(19) United States
(12) Patent Application Publication
(10) Pub. No.: US 2008/0008286 A1
(43) Pub. Date: Jan. 10, 2008

(54) Fusion energy production

(76) Inventor: Joseph M. Jacobson, Newton Center, MA (US)

Correspondence Address: Martin Moynihan;PRTSI, Inc., P.O. Box 16446, Arlington, VA, 22215, US

(21) Appl. No.: 11/800,610

(22) Filed: May 7, 2007

Related U.S. Application Data
(60) Provisional application No. 60/799,202, filed on May 9, 2006.

(51) Int. Cl. G21B 1/11

(52) U.S. Cl. 376/107

(57) ABSTRACT

Systems and methods are described for carrying out fusion reactions by changing either the Coulombic energy barrier or the reaction cross section or both. Such systems and methods are useful for creating fusion reactions which exceed energy breakeven (Q>1) and which have a relatively low cost and compact size.

This application claims priority benefit of U.S. Provisional Patent Application Ser. No. 60/______, entitled “Fusion Energy Production Means”, filed on May 9, 2006, which is incorporated herein by reference.

### BACKGROUND

The fusion of atomic nuclei (e.g. 2 Deuterium (D) atoms) can result in the production of a final product (e.g. Helium 4 (⁴He)) with lower mass than the combined mass of the constituent input nuclei and from the relation between mass and energy developed by Einstein, E=mc², we have a net production of energy. Given that c, the speed of light, is a large number the total amount of energy produced per reaction is extremely high as compared to that from any chemical reaction. As a benchmark the ratio of energy production from a nuclear fusion event compared to that of a chemical reaction is on the order of the characteristic chemical bond energy (several eV) compared to the mass conversion energy from a nuclear fusion reaction (˜several MeV) giving a net ratio of approximately 10⁶ greater energy density for the fusion reaction. Such an energy density thus makes fusion an attractive prospect for energy production for a range of applications.

The fusion reactions with the highest cross section are those of Deuterium (D)+Tritium (T)→⁴He and D+D→³He. Deuterium (D) is readily available from seawater in concentrations of ˜30 g/m³. As an example the D+D reaction yields a net energy production of 2.4×10¹² Joules which is equal to 6.6×10⁸ Watt-Hours. Thus, if all of this energy could be captured, the net energy in a U.S. Gallon of gasoline which is equal to ˜121 MJ could be supplied by the deuterium in ˜0.014 Gallons of seawater. As another example the 2005 total annual energy consumption of the United States was approximately 3.6×10¹⁵ Watt-Hours. Sufficient Deuterium to supply this energy could be isolated from ˜1.4 Billion gallons of sea water which is approximately 1 trillionth of the global sea water supply.

Although solar energy is also supplied by nuclear fusion, and considerable harvestable power (˜144,000 TW) is incident upon the earth such energy is of sufficiently low density (energy per unit area) that capture means (e.g. solar panel, harvestable bioenergy crops etc.) need be deployed over large areas which in turn can be expensive and makes difficult the direct powering of high energy density consuming appliances such as automobiles.

In order to carry out nuclear fusion, the two incident reactant species (e.g. Deuterium (D) and Tritium (T)) need to overcome their mutual electrostatic repulsion emanating from the repulsion of their mutual nuclei which are both positively charged. The coulombic barrier has an energy of approximately 0.1 MeV. As an example one successful approach to creating fusion in the laboratory is to accelerate a beam of deuterium with an energy exceeding 0.1 MeV into a solid target also consisting of deuterium in order to drive a D+D→³He reaction. Such a reaction, when completed, produces a net energy of 3.27 MeV. However since the cross section of such collisions is extremely low (<σv>/T²=1.28×10⁻²⁶ m³/s/keV²) only an extraordinarily small number of such collisions produce a fusion event and as such the energy invested in accelerating the initial deuterium ion is lost and the process as a whole does not approach the breakeven criterion (Q>1) in which net energy produced exceeds net energy expended.

Another approach is inertial confinement fusion in which a plasma of deuterium or other fusile fuel is heated to temperatures (˜10-100 KeV) sufficient that some of the atoms in the plasma have energies exceeding the coulombic barrier. In addition the plasma is confined either electrostatically (e.g. Farnsworth ‘Fusor’) or magnetically (e.g. Tokamak) such that collisions which are not successful a first time have the opportunity to recollide. The most significant development in inertial confinement fusion is the current construction of the ITER international fusion machine. This machine is expected to exceed breakeven (Q>5) but is expected to have a cost exceeding $3B for a 500 MW generator. Such economics are not currently as good as other means of energy production such a nuclear fission reactors. In addition such machines are of very large size and the scaling properties of plasma confinement make it unlikely that such machines can be made in compact forms such as might be desired for a number of applications (e.g. transportation).

Herein we describe means for carrying out fusion reactions by means of changing either the coulombic energy barrier or the reaction cross section or both. Such means are useful for creating fusion reactions which exceed energy breakeven (Q>1) and which have a relatively low cost and compact size.

### SUMMARY

The disclosure, in a first aspect, describes means for significantly enhancing the effective cross section of a beam-beam or beam target fusion reaction. In a preferred embodiment of this aspect an interferometer is used to accurately position a cluster of incident fusion reactants such that they are accelerated toward the atomic nuclei of their respective target. An alternative approach localizes fusion reactants using an optical lattice trap or other trap (e.g. ion trap) and then accelerates the trap inertial reference frame toward a respective target.

The disclosure, in a second aspect, describes means for effectively lowering the coulombic barrier between fusion reactants. In a preferred aspect of this means, said coulombic barrier is reduced by forming muonic Tritium (μT) from a Muon (μ⁻) and a Tritium (T) atom. The resulting muonic Tritium (μT) has a sufficiently reduced Bohr radius such that it has been shown to fuse with a Deuterium (D) at room temperature to form ⁴He and a neutron (n). In this process, in a high percentage of cases (˜99%) the Muon (μ⁻) is liberated and able to catalyze additional fusion reactions in an experimentally verified and established process entitled Muon Catalyzed Fusion (MCF). In a small fraction of cases (˜1%) the Muon sticks to the resulting fusion product (⁴He) and cannot catalyze additional fusion reactions. Here we disclose means for reducing the sticking probability of said Muon to said fusion product by means of incident x-ray photons of energy tuned to (or photons which have energies which are integer fractions of) the Muon-fusion product bond energy.

An alternative approach is effected by placing the electrons of an ensemble of fusion reactants in a coupled superposition state such that each electron has an increased effective mass which is a function of the total number of atoms on the fusion reactant ensemble. Such an increased effective mass, in turn, decreases the Bohr radius of the fusion reactant species yielding a lower coulombic barrier.

### BRIEF DESCRIPTION OF THE DRAWINGS

FIG. 1. Schematic drawing of inteferometric means for making incident a cluster or array of fusion reactants on a target with high precision.

FIG. 2. Schematic drawing of inteferometric means for making incident a cluster or array of fusion reactants on a target with high precision.

FIG. 3. Schematic drawing of magento-optical trap means for making incident a fusion reactant on a target with high precision.

FIG. 4. Schematic drawing of ion trap means for making incident a fusion reactant on a target with high precision.

FIG. 5. Schematic Diagram of Muon Catalyzed Fusion Cycle

FIG. 6. Schematic drawing of a means for entangling the electrons from either deuterium or tritium such that they possess a reduced mass and reduced Bohr radius.

FIG. 7. Schematic drawing of a means for reducing the sticking probability of a muon to an alpha particle in muon catalyzed fusion.

### DETAILED DESCRIPTION

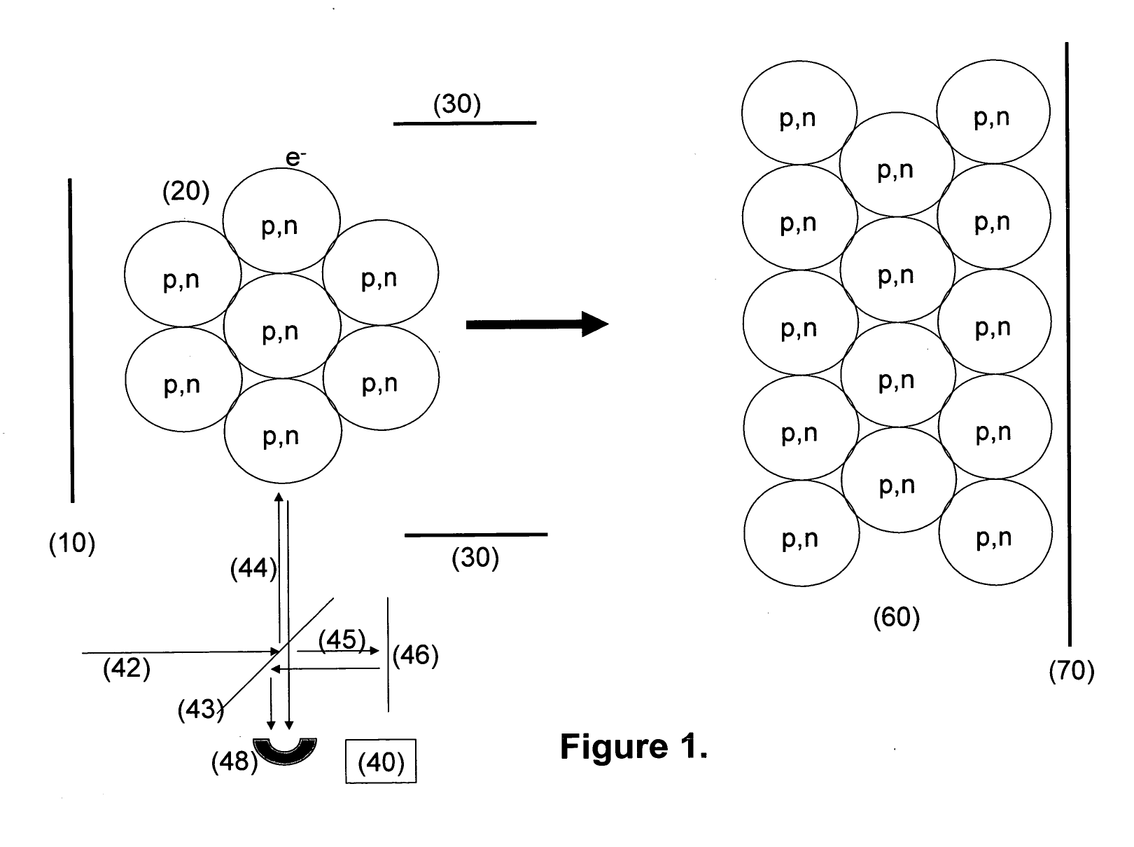

FIG. 1 shows a schematic diagram of an embodiment for significantly enhancing the effective cross section of a beam-beam or beam target fusion reaction consisting of an apparatus in which an incident cluster of deuterium atoms (20) which has at least one associated charge is incident on a target of solid deuterium (60). Such a cluster may be accelerated by means of voltage plates (10) and (70). As noted above if such a cluster is accelerated with an energy above 0.1 MeV per D atom then the coulomb barrier may be overcome and a fusion reaction carried out. That being said the probability of such a reaction is extremely small and is characterized by the cross section which for this reaction is (<σv>/T²=1.28×10⁻²⁶ m³/s/keV²). Such cross sections are well studied in the field of Rutherford scattering and are low in part because the effective size of the nucleus is very small as compared to the Bohr radius of the atom in a solid target. Such a cross section may be significantly enhanced however if means are made for ‘aiming’ the incident cluster such that nuclei of each of the incident Deuterium (D) atoms are targeted at the nuclei of the solid target. In order to carry out such targeting we employ the use of an optical interferometer (40) coupled to electrostatic deflection plates (30). Such deflection plates may be used to deflect the cluster along both axes orthogonal to the direction of motion of the cluster. The optical interferometer consists of a beam of incident photons (42) which are split by beam splitter (43) into a measurement beam (44) and a reference beam (45). Photons reflected (scattered) back from the cluster interfere with photons reflected by reference arm mirror (46) and are measured by photodetector (48) as function of the distance of reference arm mirror (46) from beam splitter (43). Such a measurement yields information about the distance from the beam splitter (43) to the cluster as is known in the art of Mach-Zender interferometers. Such information may in turn be used to govern the amount of voltage applied to electrostatic deflection plates (30) for purposes of targeting cluster nuclei to target nuclei. The interferometer (40) uses photons and it is necessary to calculate the number of photons which need to be consumed to reach a given targeting precision to ensure that the amount of energy consumed by the interferometer's photons does not exceed the amount of energy produced by the fusion reaction.

The nuclear radius of an atom is given as r=r₀A^{1/3}˜1.3×10⁻¹⁵ meter for Deuterium atoms (A=2). From the field of quantum optics we have that the uncertainty in the phase of an optical beam in a standard quantum limit interferometer is given as

$$Δ ϕ ∝ \frac{1}{\sqrt{N}}$$

where N is the number of photons. Quantum optics allows a better result, termed the Heisenberg limit, where Δφ∝1/N. Recently such Heisenberg interferometers have been constructed. As an example assume that we are using 10 eV photons (λ˜124 nm). Thus, using a Heisenberg limited interferometer we would require ˜10⁸ photons which is equal to ˜10⁹ eV in order to properly aim our fusion reactant cluster. A D+D reaction produces a total of about 3.27 MeV. Therefore in order to achieve breakeven we would need to have 10⁹/3.27×10⁶˜300 atoms in each cluster which is readily achievable in cluster beams. Since the interferometer is looking at the cluster as a whole and not individual atoms it is beneficial to cool the cluster such that the relative motion between atoms in the cluster is small. In addition it is generally useful to use smaller wavelengths (e.g. X-ray) as the scattering rates from the cluster are typically higher and more efficient.

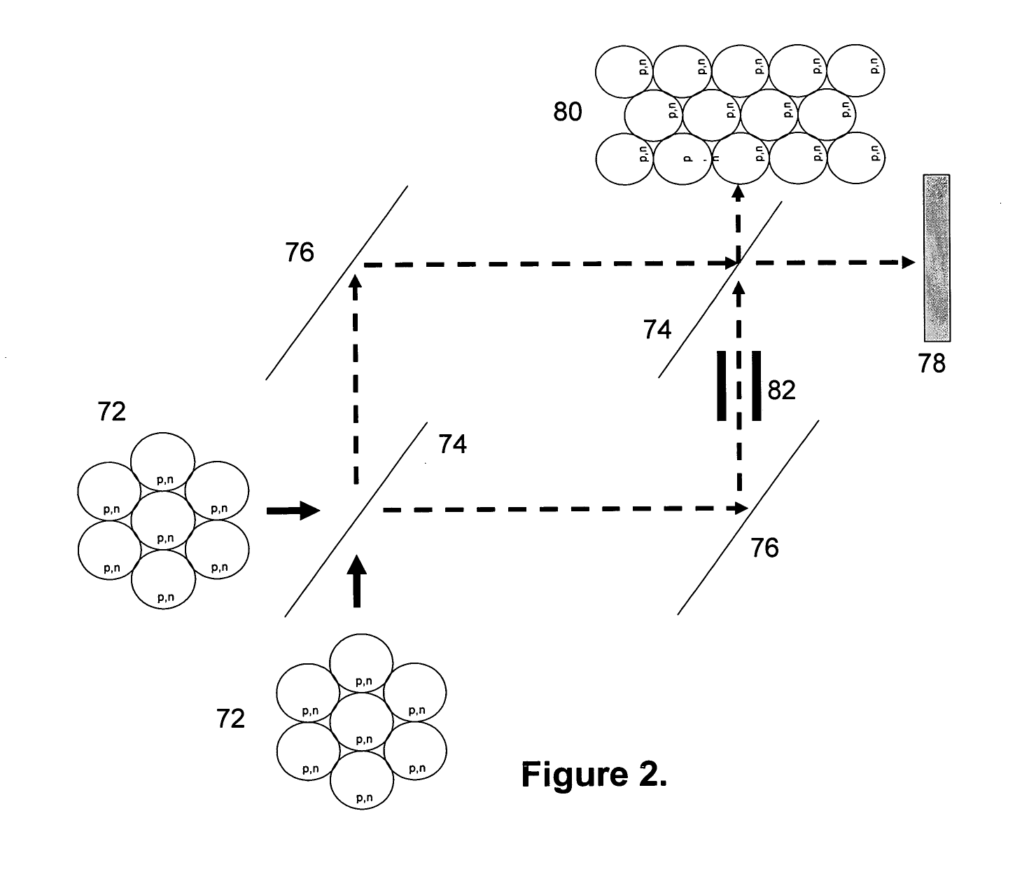

Referring to FIG. 2: Alternatively an atom interferometer may be used to aim said Deuterium clusters at said Deuterium target. Specifically incident Deuterium atoms or clusters (72) may be made incident on an atom interferometer comprising atom beams splitters (74) and atom mirrors (76). Deflection plates (82) may be used to adjust phase of said atoms as detected in detector (78) and the output of the atom interferometer may be made incident on solid deuterium target (80). In this case the atoms themselves are used to interrogate their position and to generate a feedback signal for aiming of said atoms against said target.

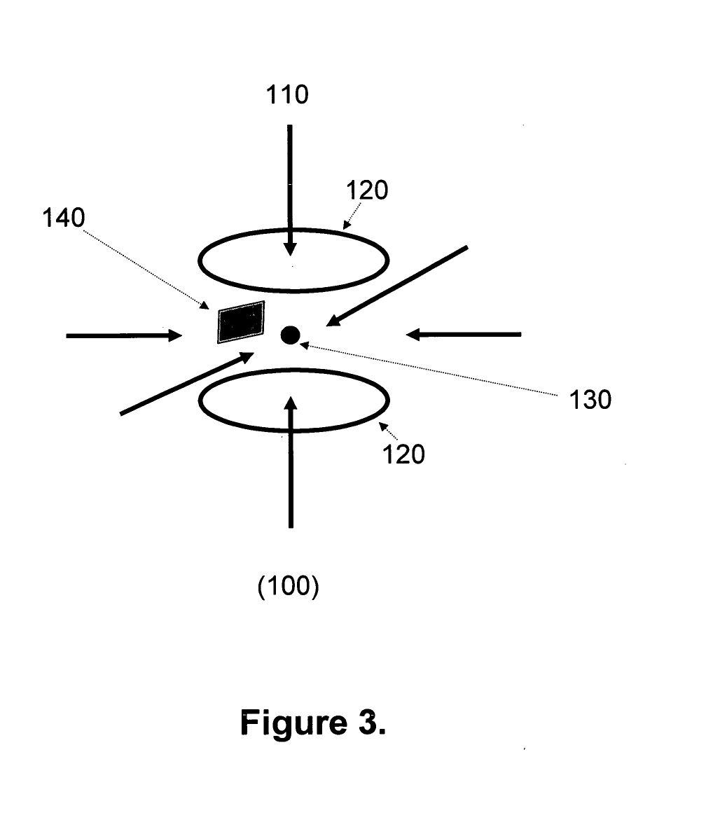

Referring to FIG. 3: Another embodiment employs a 2D or 3D magneto-optical-trap (MOT) lattice (100) in which is trapped one or more d atoms (130) which are confined to a volume well below the trapping laser wavelength λ_{TRAP}³ by laser beams (110) and magnetic field generating current rings (120) as is known in the art of optical lattices and magneto-optical-traps. In order to carry out a set of fusion reactions involving the trapped d atoms with a solid deuterium target (140) the laser beams (110) which comprise part of the optical trap are translated towards said solid target causing said trapped deuterium atoms to collide with said solid target. Such a system can localize the d reactant atoms to areas of 1 nm² or less and thus serve to increase the probability of a nuclei-nuclei collision which in turn increases the effective collisional cross section.

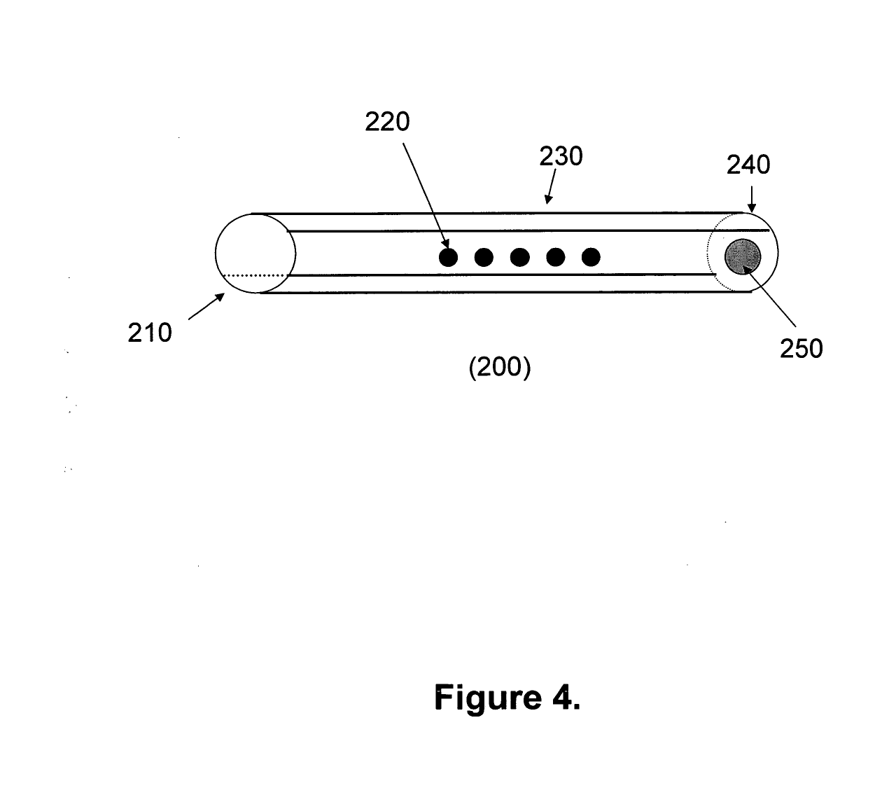

Referring to FIG. 4: Yet another embodiment consists of an ion trap for trapping ionized d atoms which are further optically cooled as is known in the field of ion traps and optical cooling. One type of ion trap is the quadropole ion trap (200) in which quadropoles (230) confine ions (220) to the axial dimension of the trap. As in the case of a MOT trap, ion traps can localize ions (220) to very small volumes. In an ion trap static electric fields generated by electrodes (210 and 240) may be used to translate ions axially along the trap. In order to carry out a set of fusion reactions involving the trapped d atoms with a solid deuterium target (250) a global static electric field is used to translate said ions within a trap such that said ions impact said solid d target (250).

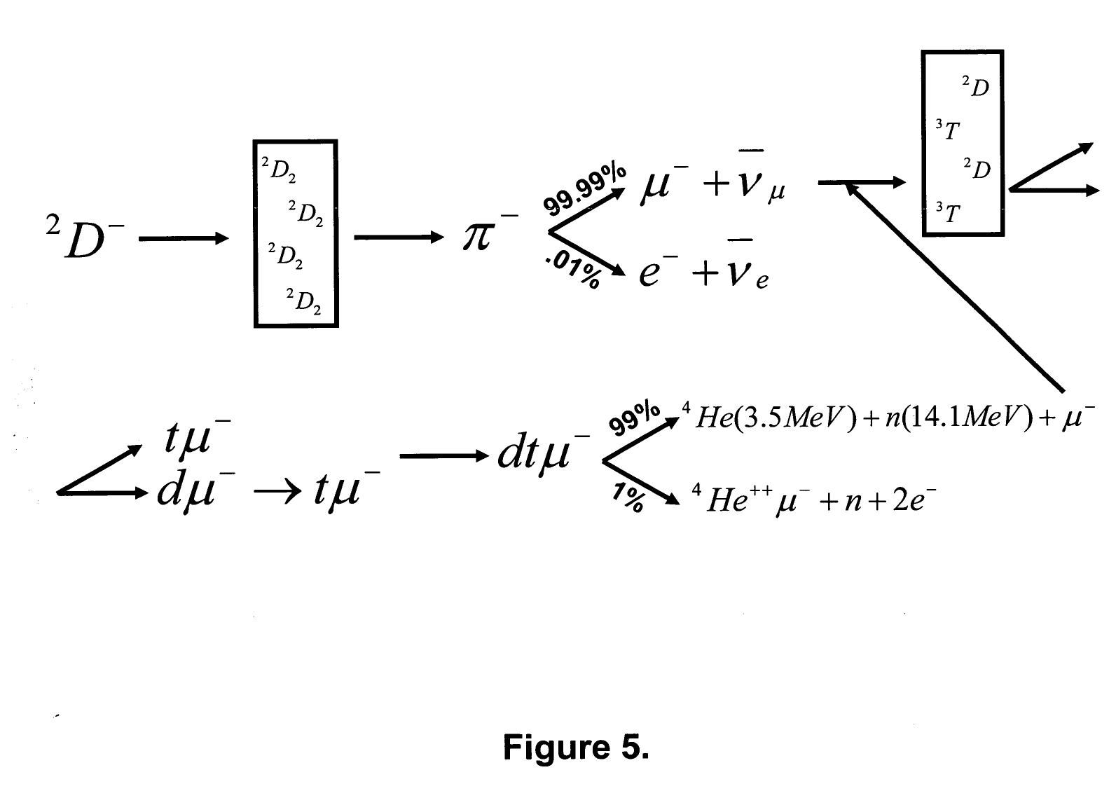

Another process for carrying out fusion is known as muon catalyzed fusion (MCF). Referring to FIG. 5, a muon catalyzed fusion cycle is shown. Here an ionized deuterium atom, ²D⁻, is accelerated (typical energies are ˜800 MeV) and made incident on a gaseous target of molecular deuterium resulting in the generation of negative Pions π⁻. Such negative Pions then decay with high probability (˜99.99%) into negative muons, μ⁻ and muon neutrinos ν_{μ}. Such negative muons are now made incident on a target of solid Deuterium and Tritium (D, T) (typically at cryogenic temperatures ˜3K). The result of such collisions is the generation of a muonic Tritium (Tμ) atoms in which the Tritium's electron is replaced with a muon. Such muonic Tritium then becomes complexed with a Deuterium to form DTμ. It was realized in the 1940's and 1950's by Frank and Zeldovich that since a muon has a mass some 207 times greater than the electron the Bohr radius of the Muon Tritium would be sufficiently small that when it becomes complexed with Deterium it will be sufficiently close to the deuterium to overcome the electrostatic barrier and fuse at room temperature. This effect was observed by L. Alvarez in the 1950's. Referring to the upper branch of the last step in FIG. 5, for a high percentage of cases (˜99%) the DTμ complex transitions into ⁴He with 3.5 MeV of energy and a neutron, n, with 14.1 MeV of energy as well as releasing the Muon, μ⁻. As indicated in the diagram this Muon can now catalyze additional fusion reactions, thus the name Muon catalyzed fusion.

An early limitation to this process though was recognized by Jackson and is depicted in the lower branch of the last process step of FIG. 5. Here the muon has a probability of ˜1% of sticking to the alpha particle, ⁴He⁺⁺, product of the fusion reaction. (Subsequent advances in enhanced resonance muon catalyzed fusion have lowered the rate of such sticking to ˜0.5%.). This poses a significant limitation towards generating net power with the MCF cycle. As detailed above the total amount of energy generated for each DT fusion is equal to 3.5 MeV+14.1 MeV=17.6 MeV. The Muon rest mass is equal to 105.6 MeV/c² however owing to inefficiencies in generating Muons it is estimated that it requires about 5 GeV to make each Muon (see, e.g. Y. V. Petrov, Nature 285, 466 (1980)). Thus in order to have break even energy production (Q>1) one requires that each Muon catalyze ˜284 (=5 GeV/17.6 MeV) fusion events. However a 1% sticking probability limits the Muon to catalyzing approximately 100 reactions.

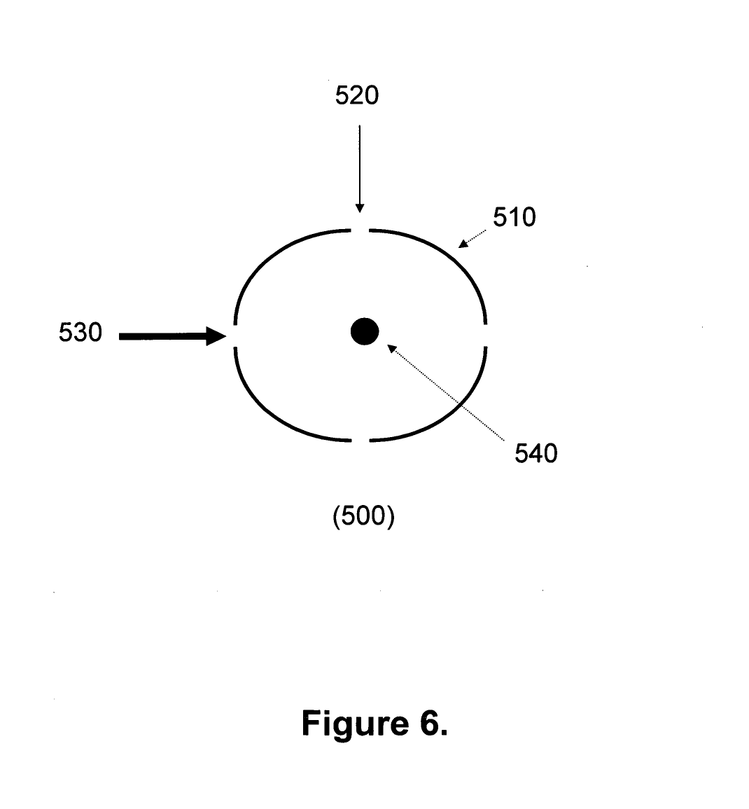

Here we describe a means for significantly reducing such Muon to Alpha Particle sticking. Referring to FIG. 6 as in known in the field of laser chemistry, bonds can be broken by means of impingent photons with energy corresponding to the energy of the bond which one wishes to break thus precluding that bond formation. The ground state energy of the Muon-Alpha particle complex is given as:

$$E = \frac{{{m}_{η} ( 2 e )}^{4}}{8 {ɛ}_{0} {h}^{2}} .$$

Thus the ionization potential is proportional to the mass of the Muon. Taking the second ionization potential of normal He as 54.4 eV we have that the bond energy between the muon and the alpha particle is equal to 54.4 eV×206.7 (the mass ration of the muon to the electron)=11.2 KeV. This corresponds to an X-Ray photon of wavelength 0.11 nm. Referring to FIG. 6 a cavity (510) has internal to it a fusion reactant target which may be a mixture of deuterium and tritium in solid or gaseous form incident upon which is a muon beam (530) and an optical beam (520) tuned to the muon-alpha particle binding energy estimated (˜11.2 KeV). The optical beam may be generated by a suitable x-ray photon source as in known in the art of high energy optical sources (e.g. free electron laser or electric discharge x-ray laser or femtosecond pulse-target source or other x-ray photon source). Said optical beam serves to reduce the muon-alpha particle sticking probability allowing said muon to catalyze a larger fraction of fusion reactions.

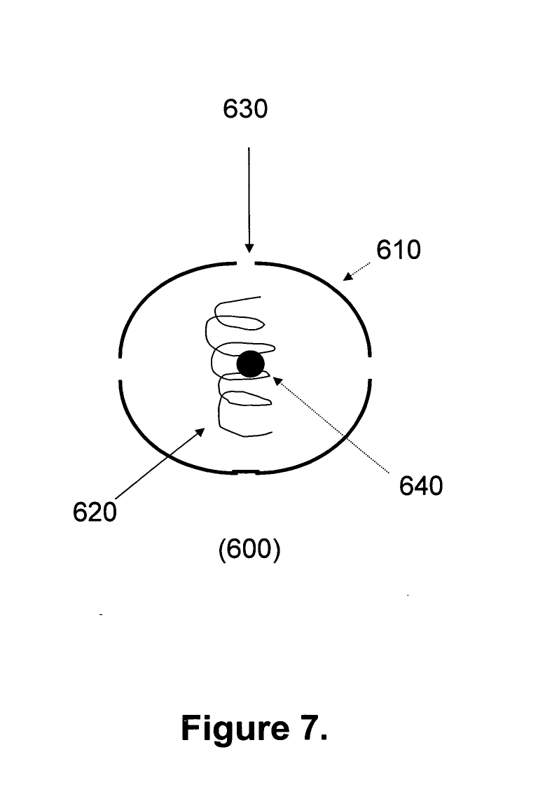

Referring to FIG. 7, Jacobson, Bjork, Chuang, and Yamamoto in their paper entitled Photonic De Broglie Waves (Physical Review Letters 74, 4835 (1995)) describe an effective Hamiltonian

$${\hat{H}}_{bs} = i ℏ \frac{π}{4} χ [ {\hat{a}}^{†} \hat{b} - {\hat{b}}^{†} \hat{a} ] + i ℏ \frac{π}{8} ( 1 - χ ) [ {( {\hat{a}}^{†} \hat{b} )}^{2} - {( {\hat{b}}^{†} \hat{a} )}^{2} ]$$

which can turn the coupling between atoms on or off. In that paper it is shown that the de Broglie wavelength is proportional to 1/(Number of coupled atoms). As described in the paragraph above, a successful means of carrying out low temperature fusion processes is to substitute the electron in tritium with the 200 times more massive muon thus decreasing the Bohr radius sufficient for the muonic tritium to approach a deuterium atom at room temperature. He we describe a similar situation however instead of using muons which are expensive (in terms of energy) to create a reduced Bohr radius we employ the idea of creating an effective Hamiltonian in which, because they are coupled to one another, the effective mass of each electron is increased and thus the Bohr radius is decreased. Referring to FIG. 7, a cavity (610) containing deuterium atoms or tritium atoms (640) has incident upon it a microwave source (630) and a magnetic field source (620) used to couple electron orbital states with the collective magnetic states of the ensemble of atoms in the cavity resulting in a Hamiltonian in which the effective mass of each atom's electron scales as the number of atoms in the ensemble thus reducing the size of the effective Bohr radius and decreasing the coulombic barrier to fusion.

As one skilled in the art will readily appreciate from the disclosure of the embodiments herein, processes, machines, manufacture, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, means, methods, or steps.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

In general, in the following claims, the terms used should not be construed to limit the systems and methods to the specific embodiments disclosed in the specification and the claims, but should be construed to include all systems that operate under the claims. Accordingly, the systems and methods are not limited by the disclosure, but instead the scope of the systems and methods are to be determined entirely by the claims.

1. A method for producing a nuclear fusion product from the fusion of two or more initial nuclei or atoms comprising:
accelerating a first initial nucleus or atom toward a second initial nucleus or atom; and,
aiming the first initial nucleus or atom at the second initial nucleus or atom.

2. The method of claim 1 wherein the aiming is performed with an accuracy of one nanometer or better.

3. The method of claim 1 wherein the aiming is carried out using an optical interferometer.

4. The method of claim 1 wherein the aiming is carried out using an atom interferometer.

5. The method of claim 1 wherein the aiming is carried out using an atom trap or ion trap.

6. The method of claim 1 wherein the amount of energy produced by a fusion reaction between the first initial nucleus or atom and the second initial nucleus or atom is greater than the amount of energy used in the system to initiate the reaction.

7. A system for producing a nuclear fusion product from the fusion of two or more initial nuclei or atoms comprising:
an accelerator that accelerates a first initial nucleus or atom toward a second initial nucleus or atom; and,
a means for aiming the first initial nucleus or atom at the second initial nucleus or atom with an accuracy of one nanometer or better.

8. A method for producing a nuclear fusion product from the fusion of two or more initial nuclei or atoms comprising:
forming a muonic atom or ion;
reacting said muonic atom or ion to another atom or ion in a fusion reaction; and,
decreasing the probability of a muon sticking to one or more nuclear products of the fusion reaction by illuminating a muon-nuclear fusion product complex with photons produced by a photon source that is tuned substantially to the ionization energy, or a submultiple of that energy, of said muon-nuclear fusion product complex.

9. The method of claim 8 wherein the photon source is an x-ray laser.

10. The method of claim 9 wherein the laser is a femtosecond pulse-target interaction type x-ray laser.

11. The method of claim 8 wherein the photon source is a synchrotron.

12. The method of claim 8 wherein the photon source is a free-electron laser.

13. The method of claim 8 wherein said nuclear fusion product comprises ⁴He and a Neutron (n) and wherein said initial nuclei or atoms comprise a Deuterium (D) and a Tritium (T) atom or nuclei.

14. The method of claim 8 wherein said nuclear fusion product comprises ⁴He and wherein said initial nuclei or atoms comprise 2 Deuterium (D) atoms or nuclei.

15. The method of claim 8 wherein the fusion of the two or more initial nuclei or atoms releases more energy than the amount of energy required to initiate the fusion reaction.

16. A method for producing a nuclear fusion product from the fusion of two or more initial atoms comprising:
placing two or more electrons from the initial atoms into a collective quantum state such that the electrons have an effective mass greater than that of a free electron.

17. A system for producing a nuclear fusion product from the fusion of two or more initial nuclei or atoms comprising:
a muon beam for forming a muonic atom or ion;
a reaction chamber for reacting said muonic atom or ion with another atom or ion in a fusion reaction; and,
a photon source for illuminating at least one resulting muon-nuclear fusion product complex with photons tuned substantially to the ionization energy, or a submultiple of that energy, of said muon-nuclear fusion product complex.
